(19) United States
(12) Patent Application Publication
(10) Pub. No.: US 2016/0125108 A1
(43) Pub. Date: May 5, 2016

(54) METHOD AND SYSTEM FOR KNOWLEDGE BASED INTERFACING BETWEEN COMPUTER AIDED ANALYSIS AND GEOMETRIC MODEL

(71) Applicant: TATA TECHNOLOGIES PTE LIMITED, Singapore (SG)

(72) Inventors: KEYUR GUPTE, Pune (IN); NIKHIL DESHPANDE, Pune (IN); PRREYA BELANKE, Pune (IN); PRAVASINI SAHU, Pune (IN); RUPALI BHOSALE, Pune (IN)

(21) Appl. No.: 14/582,187

(22) Filed: Dec. 24, 2014

(30) Foreign Application Priority Data
Nov. 3, 2014 (IN) 3474MUM/2014

(51) Int. Cl. G06F 17/50

(52) U.S. Cl. CPC G06F 17/5018

(57) ABSTRACT

Knowledge based Interface Method and System between Analysis and geometric Model, the method comprises steps of removing geometric errors both at native CAD level and neutral CAD level, and improving a geometric model based on engineering knowledge rules. Engineering rules are either previously available for known component or are built for new component. The interface system which is a computer program embodied on a computer readable medium, interacts with any out of a number of CAD platforms and CAE platforms, thus offering un-restricted selection of the combination of CAD and CAE platforms which is based on need and or preference.

### FIELD OF THE INVENTION

The present invention relates to interfacing between computer aided design (CAD) platforms and computer aided engineering (CAE) platforms. Particularly, the invention relates to interface between analysis conducted on a CAE platform and geometric model developed on a CAD platform. More particularly, the invention relates to a method and a system for knowledge based interfacing between a plurality of CAE platform and a plurality of CAD platform.

### BACKGROUND OF THE INVENTION

Since many years, computer platforms are available for three dimensional modeling of parts or components of products. Such systems are commonly known as computer aided design (CAD) platforms or software suites. Examples of such software suite are ProE, CATIA, Unigraphics, Solidworks, etc. While CAD platforms are deployed for developing any geometry, assemblies and fitment of parts or components, the performance simulation is generally carried out using computer aided engineering (CAE) software suite. Examples of such software suite are ANSYS, HyperWorks, Pro-Mechanica, NASTRON, ABACUS, ADAMS, etc. Examples of performance parameters which are to be simulated are mechanical strengths like fatigue, von moises; heat transfer; fluid flow; etc.

In product development environment, a geometric model of a part or assembly is first developed and then taken up for performance simulation. Based on results of simulation, the geometry of the part and or assembly is modified which then is again taken up for simulation and analysis. A part generally gets finalized after few or several geometric iteration.

Knowledge and skills required to work on any contemporary CAD platform and any reliable CAE platform are quite different. While a CAD engineer focuses more on overall fitment and thus geometry, a CAE engineer deploys his knowledge of materials, external conditions and product performance. Besides, operating CAE platforms themselves is quite different than operating CAD platforms. Consequently, different persons are generally assigned the CAD and CAE work.

While designing geometry of a part or assembly, CAD engineers invariably apply a set of rules, consciously or unconsciously, by virtue of his or her knowledge of the product. Conventionally, the rules are applied by use of discrete commands of CAD systems. Also, known are systems which facilitate such application of what is now known as knowledge based rules. U.S. Pat. No. 7,280,990 discloses bi-directional associativity between geometry and engineering rules.

Likewise, while simulation, CAE engineers apply their knowledge consciously or unconsciously. Here too, there are known systems which facilitate application of what is now known as knowledge based engineering.

As mentioned earlier, several CAD and also several CAE platforms are available and organizations use any CAD and any CAE platform which is based on product requirement, organizational preferences, etc.

One of the challenges is how to save time and resources, currently required due to iterative process of CAD and CAE interactions. The other challenge is to save time and resource, irrespective of whichever CAD and CAE system is in use.

There are disclosures on different kinds of integration between CAD and CAE systems. Patent CN101794337A discloses integration which facilitates performing certain basic modeling functions of CAD—like rotate, delete, copy, etc. within CAE; however this is inclusion of basic CAD features in CAE system and not knowledge based integration.

Patent Publication No: US2010/0121800 relates to an engineering design method based on construction process of knowledge components and a design process based on the knowledge components. The knowledge components pack universal modules in the standard forms. Some of the knowledge components cited are related to file parsing of text excel or word document, data format transferring, etc. It is thus clear that this disclosure is very different with respect to knowledge based rules and engineering which is essentially domain based. Accordingly, the knowledge components are independent from design layouts or design processes of products, and reusable in different projects and platforms, methods, rules and/or flows of an engineering design process and engineering analysis process.

US patent application No: US 2011/0040542 A1 discloses a method and system for the integration of functional CAE data in a CAD based styling process for industrial design. The disclosure is about three models: one for the aesthetic design process, another for the functional changes performed according to the functional quality values and yet another for “meta-model”, the approximation model for the functional model, that allows to quickly approximating the changes performed to the functional model without actually running the full functional calculations. This disclosure is a time saving process, however is not suitable for accurate performance related decision making.

While there are known knowledge based systems deployable on CAD systems and also there are knowledge based systems deployed on CAE systems, there are no known disclosure which interface knowledge based rules between CAD system and CAE system. Consequently, total time to finalize design of a part and or an assembly has a significant part of time taken to iteratively converge on the solution. In the current competitive scenario where accelerated product development is a continuous focus of organizations, there is dire need of an interface system which links CAD and CAE systems and lead to faster product design.

Our invention provides an effective industrial solution.

### OBJECTIVE OF THE INVENTION

The objective is to invent a method for interfacing between an analysis and a geometric model to carry out rules based pre-analysis checks on the geometric model prior to commencing an analysis.

Another objective is to invent a method for interfacing between an analysis and a geometric model to carry out multiple level rules based pre-analysis checks prior to commencing an analysis.

Another objective is to invent a system for interfacing between an analysis and a geometric model to carry out iterative pre-analysis checks with knowledge based rules.

Another objective is inventing an interface method to build knowledge based rules prior to carrying out analysis of a new component.

Yet another objective is to invent an interface method and system by which iterative and knowledge rules based geometric model updating and analysis is carried out with minimum repeated involvement of CAD engineer.

### SUMMARY OF INVENTION

Our invention recognizes that engineering decisions for modification of the geometric model by way of dimensional changes for achieving desired performance without affecting fitment and assembly related geometry can be converted into knowledge based rules, which are arithmetic and or logical expressions developed based on the domain and skill of a CAD engineer, amalgamated with the expertise of a CAE engineer. A method and a system as per present invention is for performing a performance analysis iteratively on a geometric model of a component so as to achieve desired value of a plurality of performance parameter. The geometric model is an existing model (EM) or a new model (NM).

For the existing model (EM), a CAE engineer alone performs the performance analysis iteratively, as per the method and system based on analysis options and a library of solution templates, till desired value of a plurality of performance parameter is achieved.

For the new model (NM), a CAD engineer and a CAE engineer collaboratively create
(a) A plurality of knowledge based rule,
(b) A plurality of analysis option for a plurality of model design parameters
(c) a library of solution templates for a geometric model with different values of performance parameters
   and the NM thus becomes the EM. A CAE engineer, thereafter, alone, performs the performance analysis iteratively, as per the method and system, based on analysis options and a library of solution templates, till desired value of a plurality of performance parameter is achieved.

The present invention is a method for Knowledge based interfacing between a Computer Aided Analysis and a Geometric Model, comprising the steps of:
a) Performing a native check for a geometric error in a geometric model of a component.
b) Applying a plurality of knowledge based rules in a native CAD platform.
c) Performing neutral check for a geometric error in a geometric model of a component.
d) On detecting geometric errors which are such that the analysis cannot be continued, then the geometric model is modified iteratively by changing parameter values of model design parameters.
e) Carrying out a finite element analysis iteratively as per analysis options and a library of solution templates.

For an EM, the plurality of analysis option and the library of solution templates pre-exist, while for an NM, the plurality of knowledge based rule, the plurality of analysis option and the library of solution templates is generated collaboratively by a CAD engineer and a CAE engineer.

The system for the Knowledge based Interfacing between the Computer Aided Analysis and the Geometric Model as per present invention is in the form of a computer program, named “MobiYES” embodied on a computer readable medium. The system performs analysis by interfacing any of the several known CAD platform (non-exhaustively—CATIA, Pro-E, NX, AUTDESK INVENTOR, etc.) with any of the several known CAE platform for different stages of CAE namely pre-processing, solving, post processing (non-exhaustively—ANSA, Hypermesh, Patran, Abaqus, Ansys, Fluent, LS Dyna, Nastran, Abaqus CAE, Hyper View, etc.).

On invoking the system, the user makes a selection for running existing library object if the model is an EM, else a NM, if it is a new geometric model. The selection of the EM is made to arrive at a geometric model with desired functional performance; while the selection of the NM is made to develop a plurality of solution templates collaboratively by a CAD engineer and a CAE engineer so as to subsequently arrive at the geometric model of this erstwhile NM with desired functional performance by treating it as the EM.

When a template of the EM is selected, the selected model template of the EM is imported in the CAD platform wherein the EM was originally developed. Layer A1: Native Model check is first executed. At this step, the geometric model is checked for geometric errors within the CAD platform where the model is originally developed. Native Model Check is performed by accessing an application programming interface (API) file of the native CAD platform. The geometric model with geometric errors cannot give useful analysis. If the geometric model has geometric errors and is not analyzable, the geometric model is iteratively taken for correction.

If the model is free from geometric errors or is assessed to be analyzable, then next execution is Model Design Parameter Inputs. Knowledge based rules and Model Design parameters already exist for an EM due to previous analysis and knowledge.

Next, comes Layer B: Design Check which is knowledge rules based check.

The updated model is saved in a neutral format like .dxf or .iges since, generally, any CAE platform needs the geometric model in the neutral format. However, it is likely that some geometric errors get formed due to such conversion from the native CAD form to the neutral format, or it is likely that previously existing geometric errors become prominent. Therefore, next execution is Layer A2: Neutral Model Check.

If the geometric model has geometric errors and is not analyzable, the model is iteratively taken for correction.

If the geometric model is free from geometric errors or is assessed to be analyzable, then next execution is a CAE analysis.

The system is capable of integrating the CAE analysis by selecting any of the different pre-processors Solvers and post processors.

A CAE analysis result obtained after post processing is studied. If the CAE analysis result obtained is not acceptable with respect to expected performance of the geometric model, then model design parameters are iteratively edited as per Analysis Option and Analysis Option Value, and the above steps are re-executed. Reference Results are used for decision making.

On selecting the NM, since the geometric model is a new model, there is no model template pre-existing in the system. A geometric model of the NM is created in the preferred CAD platform. The geometric model is opened in the native CAD platform, that is, wherein the new model was developed.

Layer A1: Native Model check is first executed. At this step, the geometric model is checked for geometric errors in the native CAD platform, that is, within the CAD platform where the model is originally developed. If the geometric model has geometric errors and is not analyzable, the geometric model is iteratively taken for correction.

If the geometric model is free from geometric errors or is assessed to be analyzable, then next execution is Parameter User Interface: Inputs for Model Design Parameter, Environmental parameters and Constraints are provided by the user in the form of expressions. Since the model is a NM, no expressions may previously exist other than expressions used by a CAD engineer in developing the model. The user collaboratively develops expressions based on skill, experience and domain knowledge. An expression is built around the impacted model design parameter.

The expressions are validated for syntax by the user. The model is updated.

If the model has geometric errors and is not analyzable, the model is iteratively taken for correction.

Next, comes Layer B: Design Check which is knowledge rules based check.

The updated geometric model is saved in a neutral format like .dxf or .iges. The system as per present invention next executes Layer A2: Neutral Model Check.

If the geometric model has geometric errors and is not analyzable, the geometric model is iteratively taken for correction.

If the geometric model is free from geometric errors or is assessed to be analyzable, then next execution is CAE analysis. The intent here, however, is to generate a number of solution templates collaboratively for creating a library of solution templates.

Collaboratively, the CAD and CAE engineer generate a plurality of result files, that is solution templates, by assigning experimental Analysis Option values and create a library of templates for subsequent use.

As is understood from above, the NM option of the system causes building a library of solution templates by collective knowledge of a CAD engineer and a CAE engineer on a one time basis, so that subsequent analysis of the erstwhile NM, is carried out by the CAE engineer all alone by applying analysis option values and taking reference from solution templates, which are based on knowledge based rules created as hereinabove.

The library of solution templates dynamically grows as the result of every CAE analysis is appended therein. Thus the knowledge base as per the system and the method disclosed is self-enriching and self-refining with continued application of the method and the system.

Since the system is a knowledge based interface, tens of model templates may cumulate for an EM. The CAE engineer elects to either develop another template regardless of availability of an identical model template already, or else uses another software utility to search and select the available template.

The system as per present invention is ancillary to complex PLMs and three-dimensional software suites, which are hugely complex platforms supplementing human capabilities, which our system further complements by providing a knowledge based interfacing between them.

Our inventive system for knowledge based interfacing between computer aided analysis and geometric model, is installable on specific hardware and or workstations which support industrial PLM tools, contemporary CAD platforms and CAE platforms, which are typically workstations with 32/64 bit operating system, with recommended processor speed of 2.0 GHz and with active LAN Adapter.

### BRIEF DESCRIPTION OF DRAWINGS

FIG. 1 shows higher level steps of a method for Knowledge based Interfacing between Computer Aided Analysis and Geometric Model for new as well as existing geometric model.

FIG. 2 shows flow diagram of deciding existing model or New Model to be analyzed.

FIGS. 3, 3A and 3B show flow diagram of steps when existing model is to be analyzed.

FIGS. 4, 4A, 4B and 4C show flow diagram of steps when new model is to be analyzed.

FIG. 5 shows architecture of a system as per present invention and linkage between the system and a plurality of CAD platforms, a plurality of CAE platforms, and CAD templates.

FIG. 5A shows hardware architecture and configuration requirement for the system.

FIG. 6 shows a connecting rod as existing model, built in CATIA CAD platform, used for describing the system.

FIG. 7 shows illustrative screens of the system for template of existing model and as per a CAD platform, selected from several options.

FIG. 8 shows illustrative screen of the system for the template model in the CAD model as seen within the system viewer. Another computer screen shown therein is of the selected CAD platform opening in the background.

FIG. 9 shows a result file obtained after Layer A1: Native Model check.

FIG. 10 shows illustrative screen of the system showing knowledge based rules, involving model design parameters, environmental parameters and Geometry Constraints.

FIG. 11 shows a result file obtained after Layer A1: Neutral Model check.

FIG. 12 shows illustrative screen of the system for User interface of selecting auto meshing and preprocessing platform from available platforms.

FIG. 13 shows illustrative screen of the system for User interface of selecting solver platform, post processing visualizer and report from available options.

FIG. 13A shows an illustrative screen showing shaded image of a CAE result along with corresponding parameter values as obtained from the selected post processing solver.

FIG. 14 shows illustrative screen of the system giving results of the analysis, previous results and Analysis options for iterating the CAE analysis.

FIG. 15 shows a bracket as a new model, built in CATIA CAD platform, used for describing the system.

FIG. 16 shows illustrative screen of the system for the template model in the CAD model as seen in the system viewer and also shows a result file obtained after Layer A1: Native Model check.

FIG. 17 shows illustrative screen of the system for knowledge based rules involving model design parameters, environmental parameters and Geometry Constraints.

FIG. 18 shows illustrative screen of the system showing execution of Geometry Constraints.

FIG. 19 shows a result file obtained after Layer A1: Neutral Model check.

FIG. 20 shows illustrative screen of the system for User interface of selecting auto meshing and preprocessing platform from available platforms.

FIG. 21 shows illustrative screen of the system for User interface of selecting solver platform, post processing visualizer and report from available options.

FIG. 21A shows an illustrative screen showing shaded image of a CAE result along with corresponding parameter values as obtained from the selected post processing solver.

FIG. 22 shows illustrative screen of the system giving results of the analysis, previous results and Analysis options for revising limits of parameters.

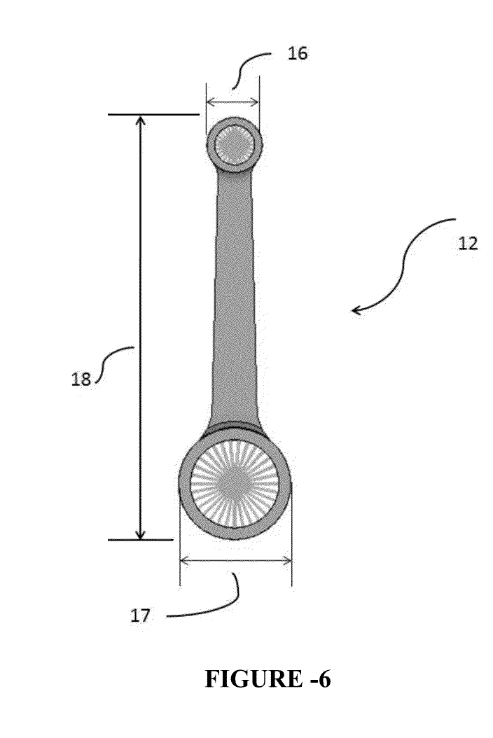

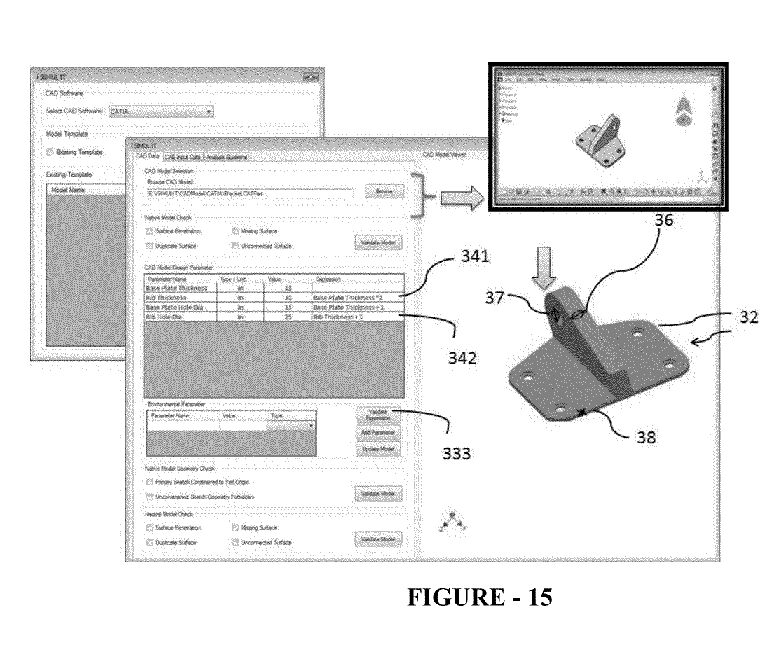

FIG. 6 to FIG. 14 pertains to an existing model while FIG. 15 to FIG. 22 pertains to a new model.

### DETAILED DESCRIPTION OF INVENTION

The invention shall now be described with the help of drawings and illustrations, which should be construed merely for description and not for limiting the invention. Anyone skilled in the art can understand that the present invention may have additional embodiments, or that the present invention may be practiced without several of the details described in the following description.

Definitions and explanation of terms used in the description:

Performance analysis—A computer aided engineering analysis of a geometric model for mechanical, fluidic, thermal and or such functional or performance parameters as fatigue, von moises; heat transfer; fluid flow.

Knowledge based rule—Definable engineering rule which could be a relational rule, a functional rule, an environmental rule or any other discrete rule or a set of rules, in the form of an arithmetical or a logical expression.

Analysis Option—Limiting freedom and value of a model design parameter based on functional or performance parameter.

Relational rule—An arithmetic logic between two or more model design parameters, also known as dimensions, of a component. Example: Parameter A=0.5*Parameter B

Functional rule—An arithmetic logic between a functional parameter and a plurality of model design parameter of a component. Example: Shear stress=Parameter C *2.

Environmental rule—An environmental parameter or guideline generally originating from external sources and which impacts a function and or a dimension. Example—Minimum safety factor to be TWICE the load value for a particular country or a particular product standard.

Geometric model—a three dimensional CAD model of a component, developed on any of the known CAD software suite like CATIA, Pro-E, NX, AutoDesk Inventor or any contemporary platform.

An Existing model or an EM—A Geometric model belonging to a family of component previously analyzed and or for which some or all knowledge based rules pre-exist in a system as per this invention.

A new model or a NM—A Geometric model which needs to be analyzed for the first time and for which no similar component was analyzed previously and or for which knowledge based rules do not pre-exist.

Geometry Constraint—An engineering constraint incorporated while building a geometric model. Geometric constraints are incorporated for relative constraining of a plurality of dimension with respect to an origin and or for relative constraining of any dimension with respect to another dimension. Geometry Constraint is generally a good engineering practice, which when not incorporated may lead to absurd model while applying knowledge based rule.

Geometric error—An anomaly in a geometric model, which may cause absurdity in analysis results. Solid model defect, Surface defect, Geometry constraint, are kinds of geometric errors.

Native CAD platform—A CAD platform where a geometric model is created.

Native Check or Native Model Check—Validation performed in the native CAD platform.

Neutral Check or Neutral Model Check—Validation performed in a manner independent of the CAD platform where a geometric model is created.

Solution Template—Analysis results along with corresponding values of model design parameters and corrective measures to arrive at the parameters and analysis results.

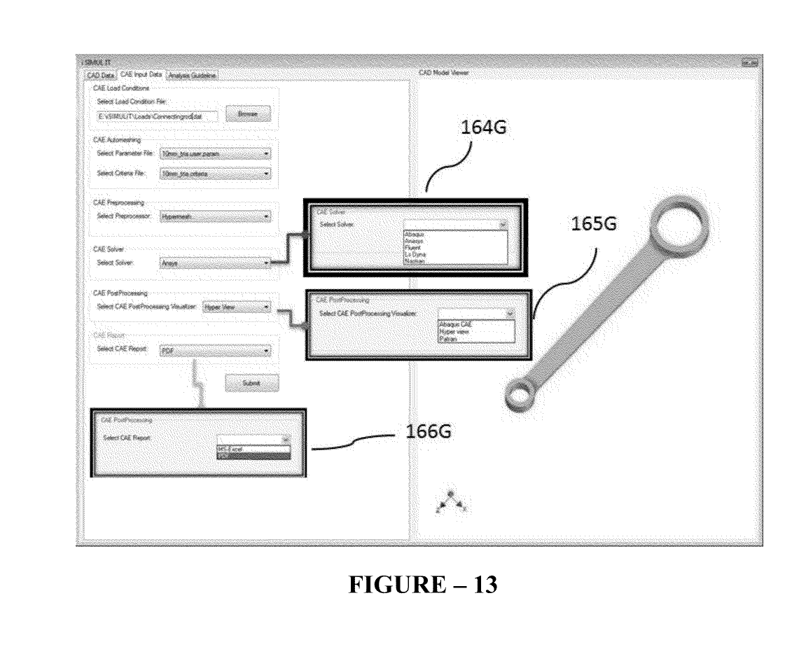

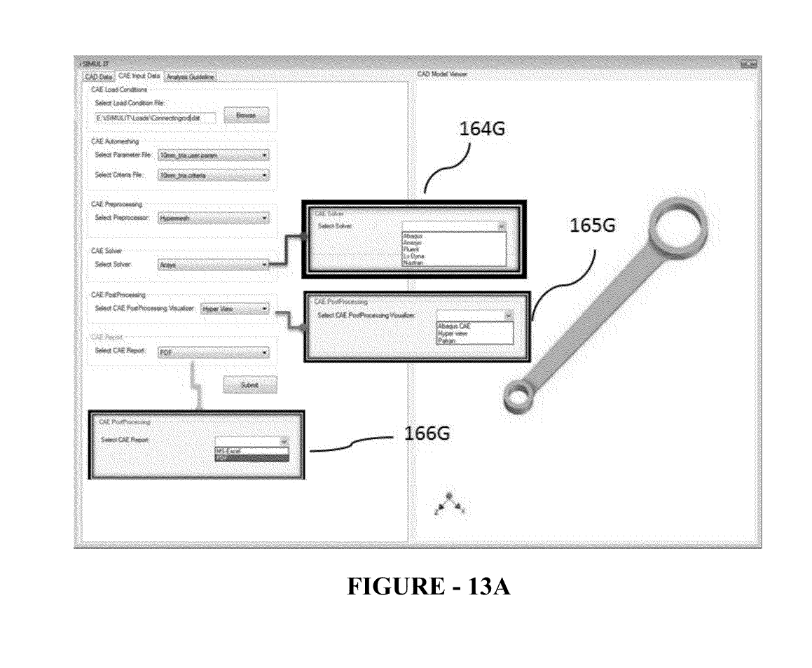

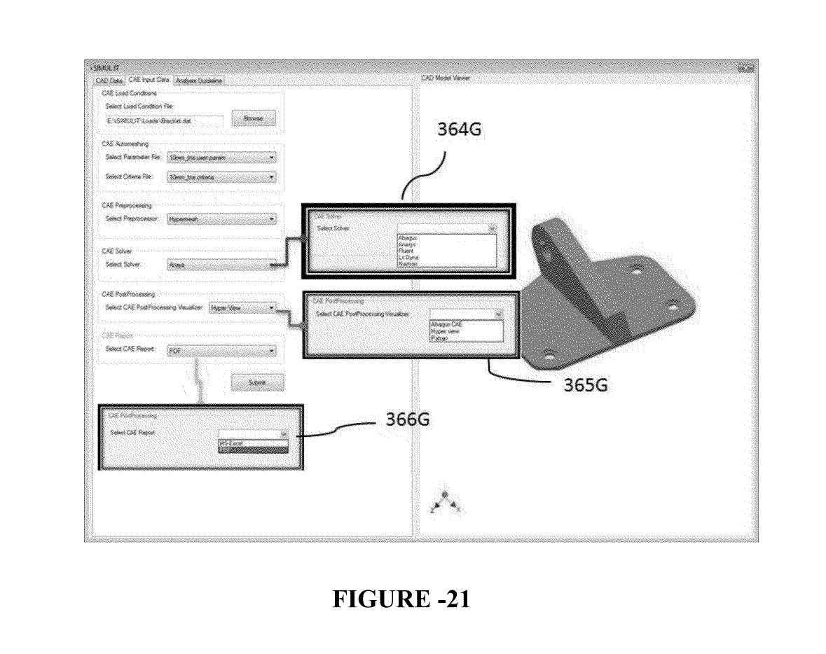

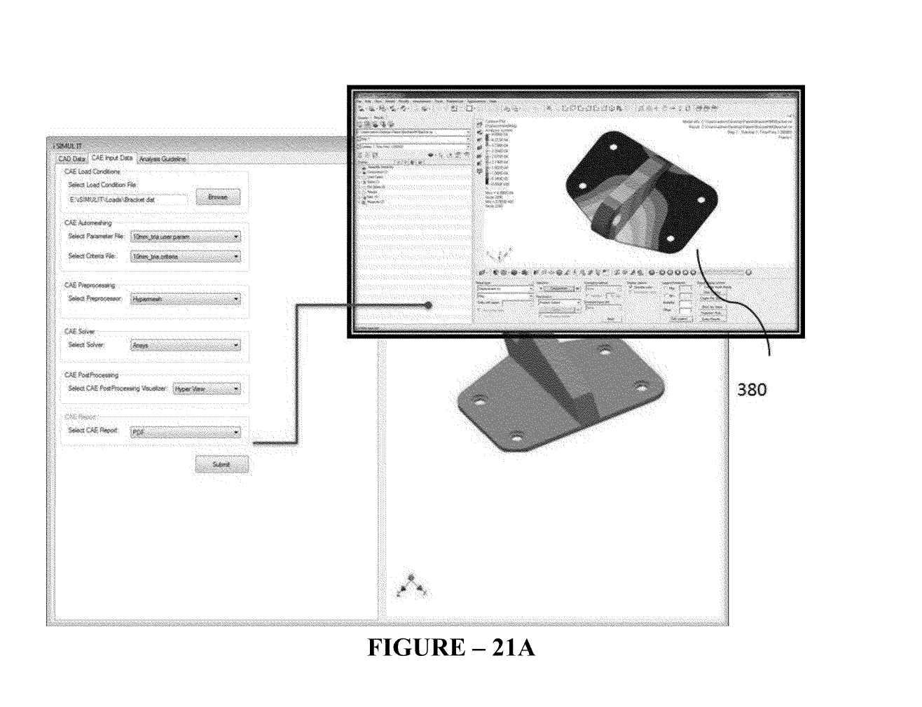

Performance analysis is performed by a CAE engineer for arriving at a geometric model of the component which when manufactured shall have desired functional or performance parameters. Almost invariably, dimensional changes are required to be done in the geometric model in order to arrive at the desired level of performance parameters, without affecting the fitment and assembly related geometry of the component. Generally, such dimensional changes are carried out by a CAD engineer, preferably who originally develops the component. The CAD engineer makes such dimensional changes after studying a CAE analysis result. The CAE analysis results are generally in the form of a plurality of images of the component with differential color shades and with performance values corresponding to each color shade, as can be seen (180) and (380) in FIG. 13A and FIG. 21A respectively.

This iterative process of analysis by CAE engineer, interpretation by CAD engineer, modification in the geometric model by CAD engineer, re-analysis by CAE engineer, till satisfactory performance parameters are obtained, is time consuming and therefore adversely impacts the product development schedules.

Our invention recognizes that engineering decisions for modification of the geometric model by way of dimensional changes for achieving desired performance without affecting fitment and assembly related geometry can be converted into knowledge based rules, which are arithmetic and or logical expressions developed based on the domain and skill of a CAD engineer, amalgamated with the expertise of a CAE engineer. Consequent to such knowledge based rules; analysis options and a library of solution templates are created which can be applied by the CAE engineer thus avoiding the unnecessary dependence on CAD engineer by curtailing to and fro process of sending and receiving the geometric model for modification of the geometric model by CAD engineer.

A method and a system as per present invention is for performing a performance analysis iteratively on a geometric model of a component so as to achieve desired value of a plurality of performance parameter. The geometric model is an existing model (EM) or a new model (NM).

For the existing model (EM), a CAE engineer alone performs the performance analysis iteratively, as per the method and system based on analysis options and a library of solution templates, till desired value of a plurality of performance parameter is achieved.

For the new model (NM), a CAD engineer and a CAE engineer collaboratively create
(a) A plurality of knowledge based rule,
(b) A plurality of analysis option for a plurality of model design parameters
(c) a library of solution templates for a geometric model with different values of performance parameters
   and the NM thus becomes the EM. A CAE engineer, thereafter, alone, performs the performance analysis iteratively, as per the method and system, based on analysis options and a library of solution templates, till desired value of a plurality of performance parameter is achieved.

The present invention is a method for Knowledge based interfacing between a Computer Aided Analysis and a Geometric Model, comprising the steps of:
(a) Performing a native check for a geometric error in a geometric model of a component.
(b) Applying a plurality of knowledge based rules in a native CAD platform.
(c) Performing neutral check for a geometric error in a geometric model of a component.
(d) On detecting geometric errors which are such that the analysis cannot be continued, then the geometric model is modified iteratively by changing parameter values of model design parameters.
(e) Carrying out a finite element analysis iteratively as per analysis options and a library of solution templates.

For an EM, the plurality of analysis option and the library of solution templates pre-exist, while for an NM, the plurality of knowledge based rule, the plurality of analysis option and the library of solution templates is generated collaboratively by a CAD engineer and a CAE engineer.

The system for the Knowledge based Interfacing between the Computer Aided Analysis and the Geometric Model as per present invention is in the form of a computer program, named “MobiYES” embodied on a computer readable medium. The system performs analysis by interfacing any of the several known CAD platform (non-exhaustively—CATIA, Pro-E, NX, AUTDESK INVENTOR, etc.) with any of the several known CAE platform for different stages of CAE namely pre-processing, solving, post processing (non-exhaustively—ANSA, Hypermesh, Patran, Abaqus, Ansys, Fluent, LS Dyna, Nastran, Abaqus CAE, Hyper View, etc.).

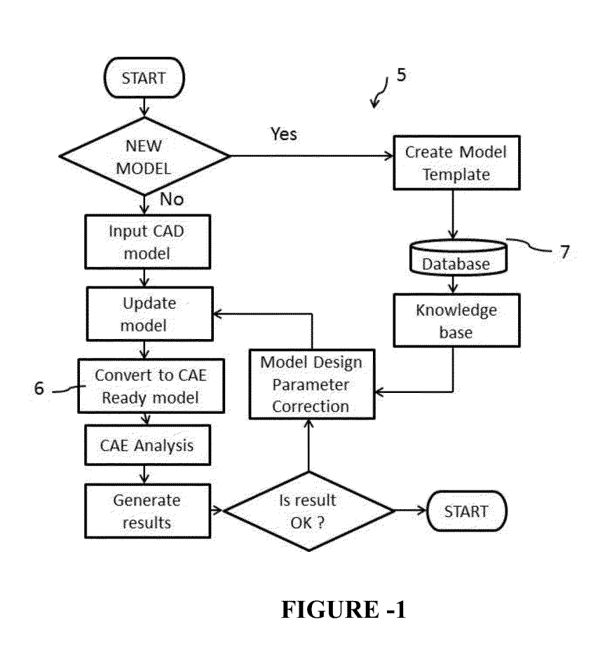

As shown in FIG. 1, the method (5) as per present invention is for an existing model as well as for a new model. For an existing model, the method looks for and imports from a database (7) the Model template from a selected CAD platform and the corresponding CAD platform runs in the background. For a new model, the method first creates and then retrieves the Model template from a selected CAD platform and the corresponding CAD platform runs in the background. After building or editing AND validating the expressions, the geometric model is updated and examined for geometric errors and is improvised to “CAE ready MODEL” (6) in line with the method as per present invention. The CAE analysis is then undertaken as per known steps.

As shall be described below, for a model to be a “CAE ready MODEL” (6) three layer checks are done:
(1) Layer A1: Native Model Check
(2) Layer B: Knowledge based rules check.
(3) Layer A2: Neutral Model Check

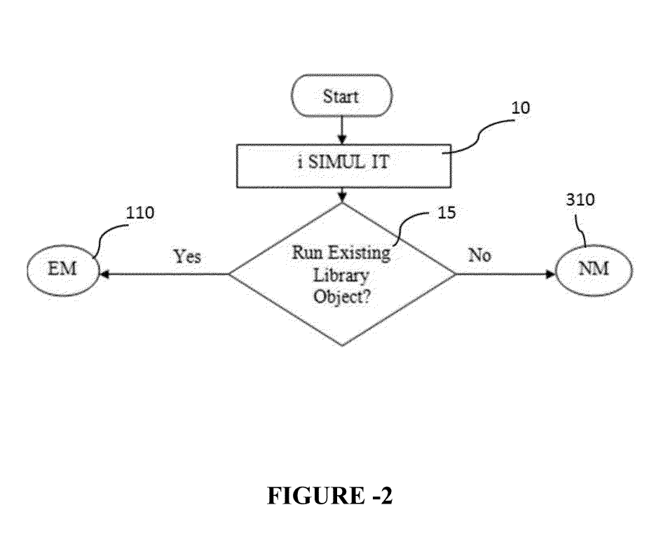

As shown in FIG. 2, on invoking the system (10), which is a computer programme named “MobiYES”, the user makes a selection for running existing library object (15) if the model is an EM (110), else a NM (310), if it is a new geometric model. As shall be described below, the selection of the EM (110) is made to arrive at a geometric model with desired functional performance; while the selection of the NM (310) is made to develop a plurality of solution templates collaboratively by a CAD engineer and a CAE engineer so as to subsequently arrive at the geometric model of this erstwhile NM (310) with desired functional performance by treating it as the EM (110).

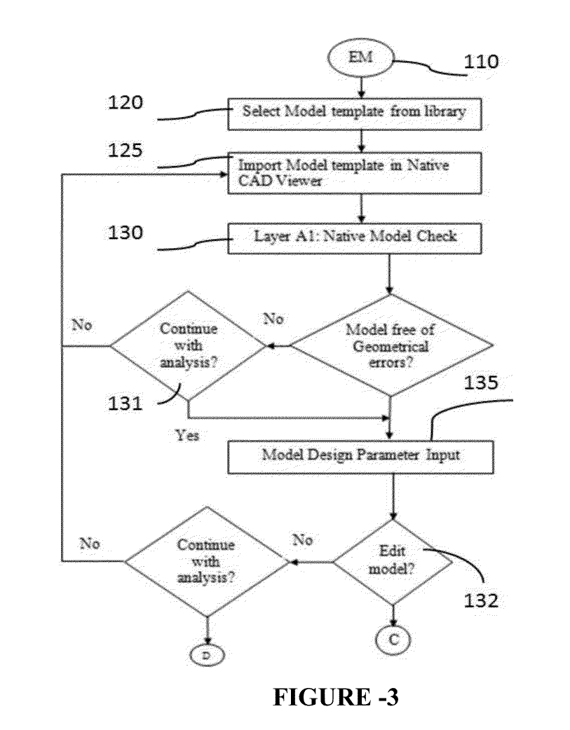

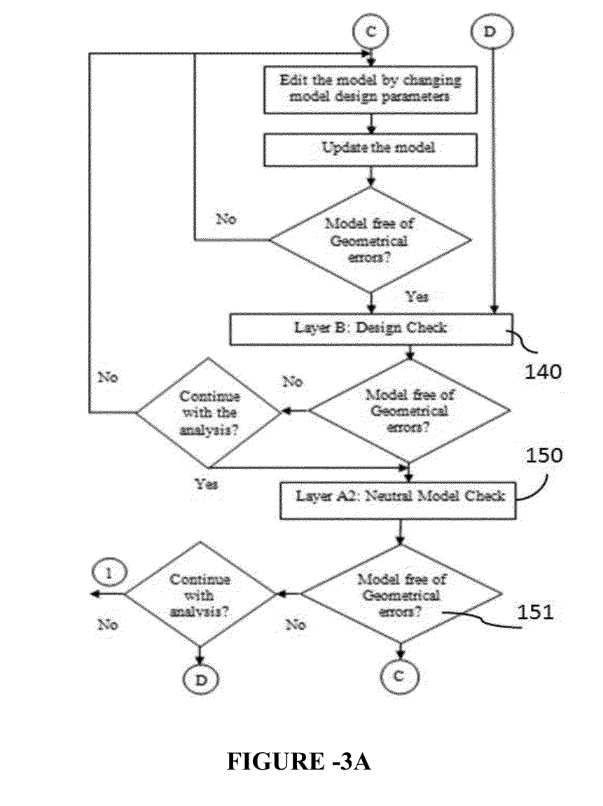

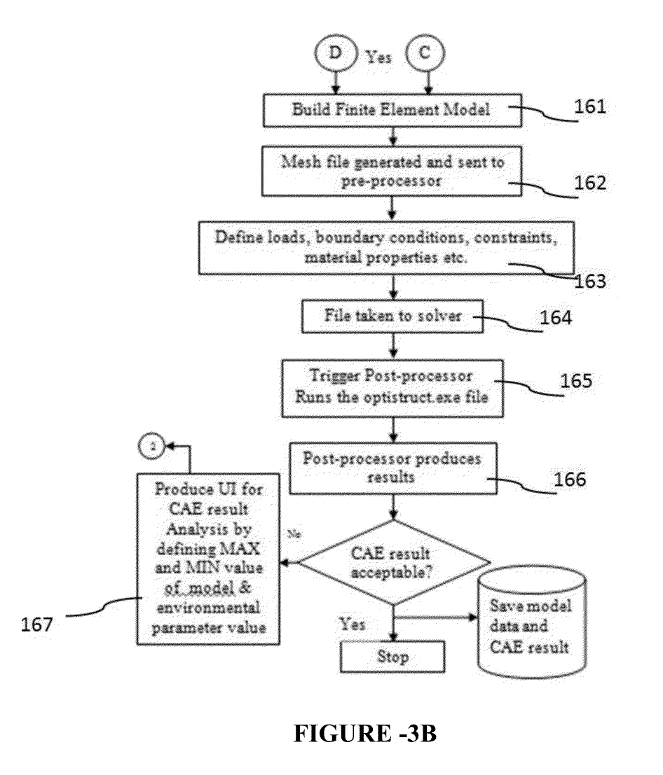

FIGS. 3, 3A and 3B show the steps on selecting the EM (110). The EM (110) is a connecting rod (12), as shown in FIG. 6, taken for illustrating the inventive system (10). Figure number(s), wherever given at the end of a para is of the corresponding computer screen of the system.

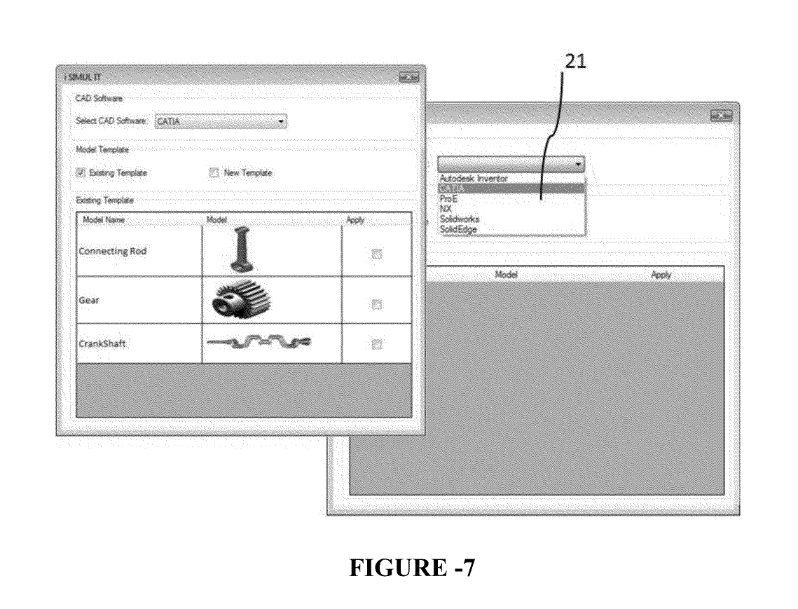

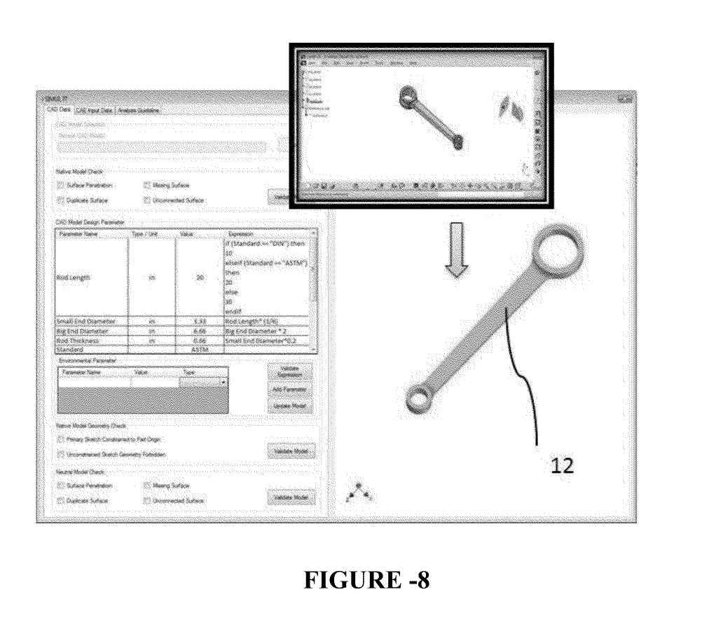

A template of the EM (110) is selected (120). The selected model template of the EM (110) is imported in the CAD platform wherein the EM (110) was originally developed, which is therefore termed as a Native CAD viewer (125) where the model template was developed, example CATIA or Pro-E or NX or any other CAD platform (21). FIG. 7, FIG. 8.

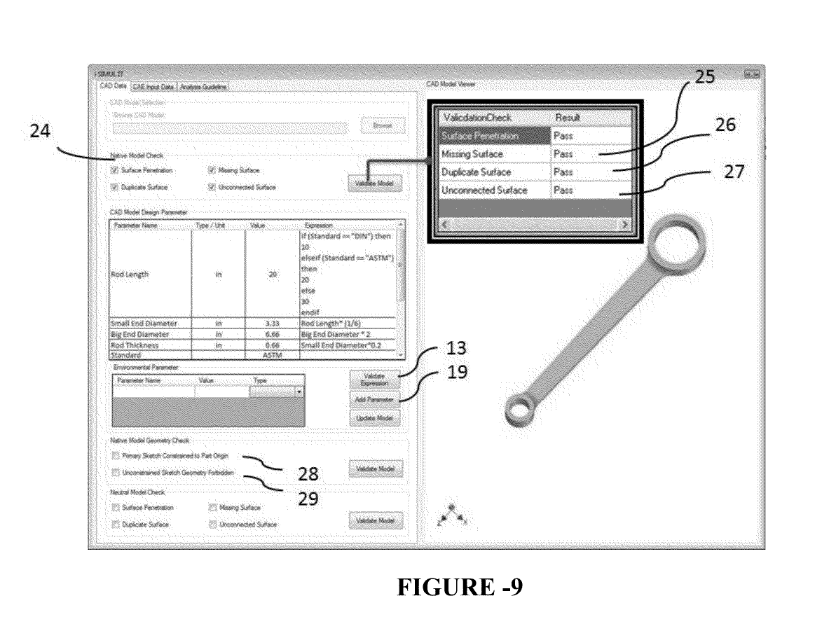

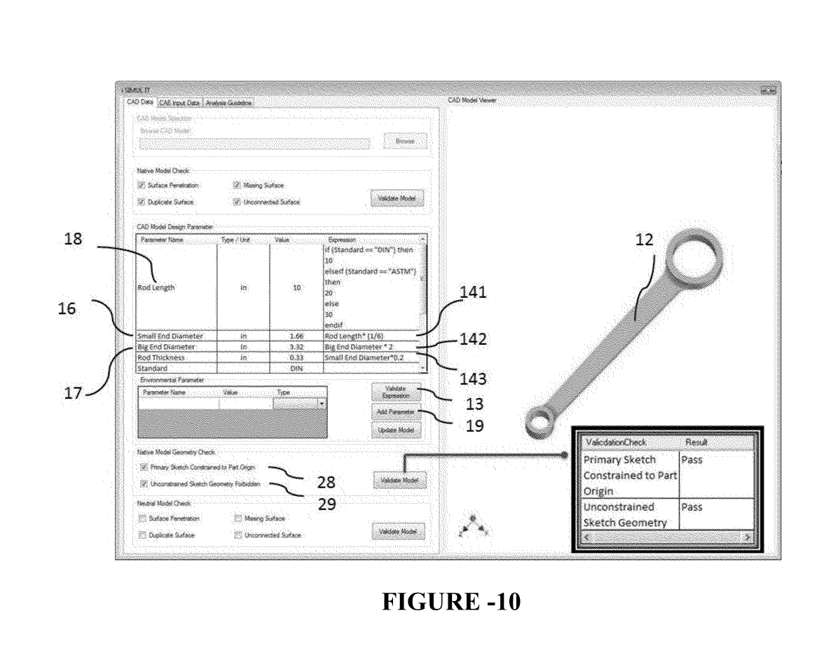

Layer A1: Native Model check (130) is first executed. At this step, the geometric model is checked for geometric errors within the CAD platform where the model is originally developed. Native Model Check (130) is performed by accessing an application programming interface (API) file of the native CAD platform. API file are well known to persons skilled in the art. Geometric errors illustratively include solid model defects, surface penetration (24), missing surface (25), duplicate surface (26), uncorrected surface (27), Constraint to Origin (28), Constrained Geometry (29). Such geometric errors crop-in while making the geometric model and are not easily detectable by persons making a CAD model or doing an analysis. FIG. 9, FIG. 10.

The geometric model with geometric errors cannot give useful analysis. If the geometric model has geometric errors and is not analyzable, the geometric model is iteratively taken for correction (131).

If the model is free from geometric errors or is assessed to be analyzable, then next execution is Model Design Parameter Inputs (135). Knowledge based rules and Model Design parameters already exist for an EM (110) due to previous analysis and knowledge. However, new knowledge based rules and new model design parameters can be added (19) as also the existing knowledge based rules and the model design parameters can be edited. After addition and or editing, the expression is validated (13) as shown in FIG. 10.

Since the model is an EM (110), the EM (110) is optionally updated iteratively (132) and correspondingly checked for geometric errors.

Next, comes Layer B: Design Check (140) which is knowledge rules based check. Illustration with reference to connection rod (12):
A big diameter (17) of to be greater than or equal to twice a small diameter (16)—see (142) FIG. 10
The small diameter (16) to be greater than or equal to one-sixth of a rod length (18) of connecting rod (12)—see (142) FIG. 10

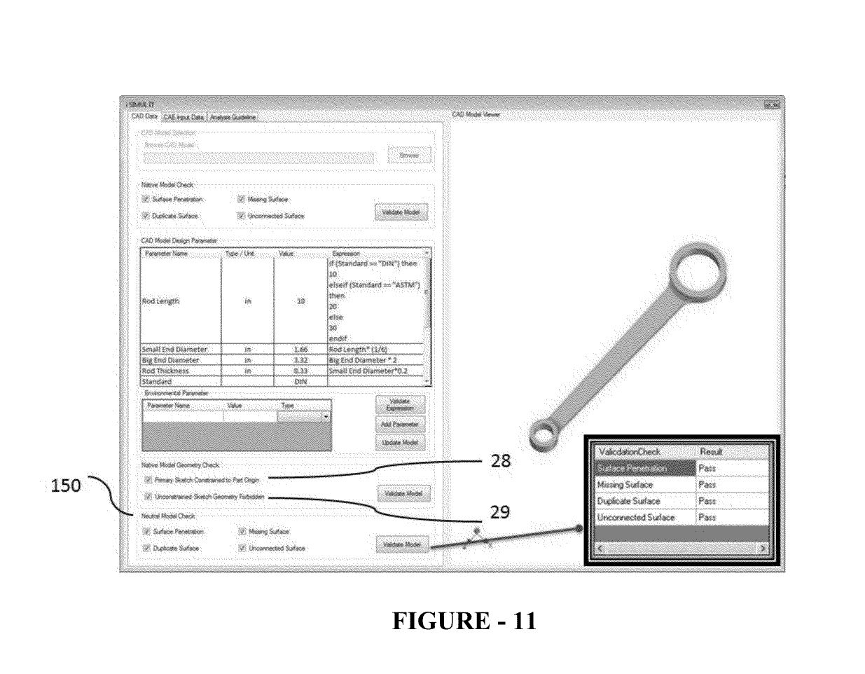

The updated model is saved in a neutral format like .dxf or .iges since, generally, any CAE platform needs the geometric model in the neutral format. However, it is likely that some geometric errors get formed due to such conversion from the native CAD form to the neutral format, or it is likely that previously existing geometric errors become prominent. Therefore, next execution is Layer A2: Neutral Model Check (150) by the system (10) as per present invention .FIG. 11.

If the geometric model has geometric errors and is not analyzable, the model is iteratively taken for correction (151).

If the geometric model is free from geometric errors or is assessed to be analyzable, then next execution is a CAE analysis. As is known, CAE analysis comprises the known steps of
Building a Finite Element Model abbreviated as FEM (161)
Defining loads, boundary conditions, constraints and material properties(163)
Solving the Finite Element Model (164)
Post processing the Finite Element Model (165)
Generating result file (166).

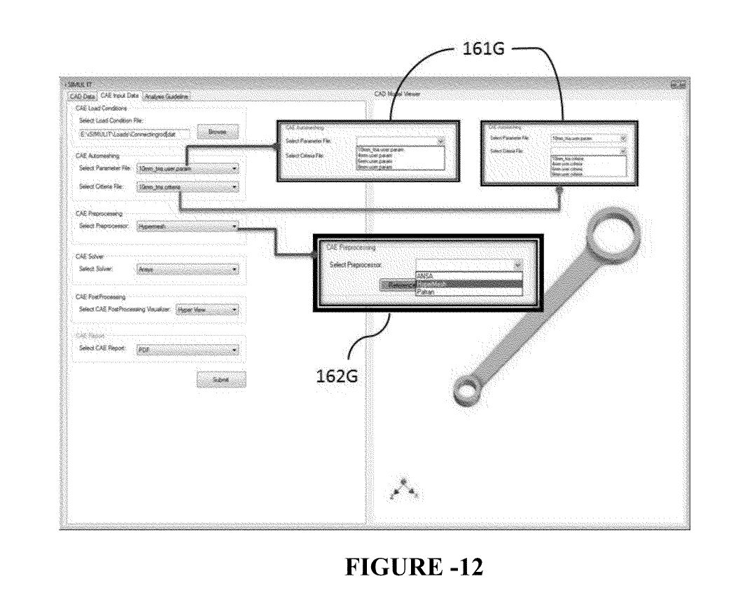

The system is capable of integrating the CAE analysis by selecting any of the different pre-processors (162G) Solvers 164G) and post processors (165G) as shown in FIG. 12 and FIG. 13.

A CAE analysis result (180) obtained after post processing is studied. If the CAE analysis result (180) obtained is not acceptable with respect to expected performance of the geometric model, then model design parameters are iteratively edited (167) as per Analysis Option (170a) and Analysis Option Value (170b), and the above steps are re-executed. Reference Results (169) are used for decision making. FIG. 13A.

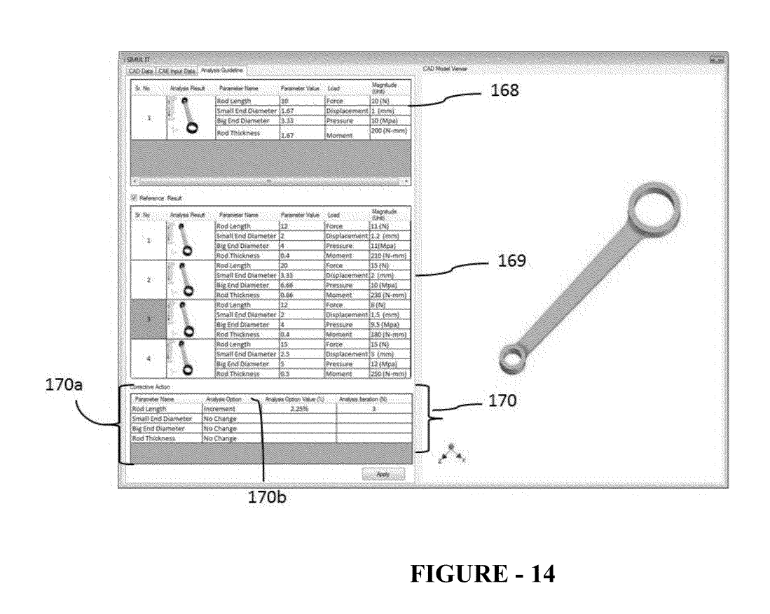

FIG. 14 shows Analysis Result (168), Reference Results (169) and Analysis Options Menu (170). Reference results (169) are solution templates of previous analysis, while analysis options Menu (170) are factors for iterating the analysis by deciding incremental change, number of iterations etc. with respect to a plurality of model design parameters.

The CAE result is studied by
Arithmetic assessment of obtained value of performance parameter like displacement, stress, temperature; and comparison with desired values, or
pixel assessment of obtained shades of differential color image with desired values, or
logical assessment of values of obtained result as extracted from application programming interface (API) file of the CAE platform
   or by a combination of arithmetic, pixel and logical assessment.

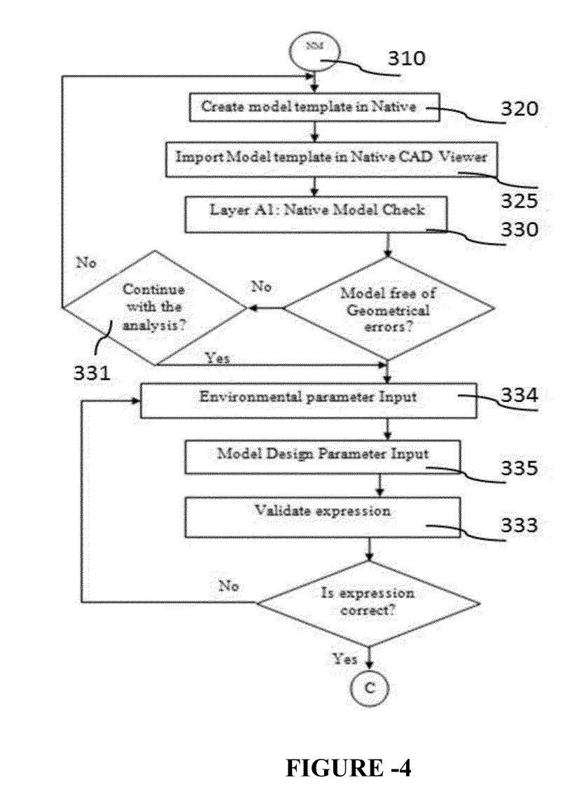

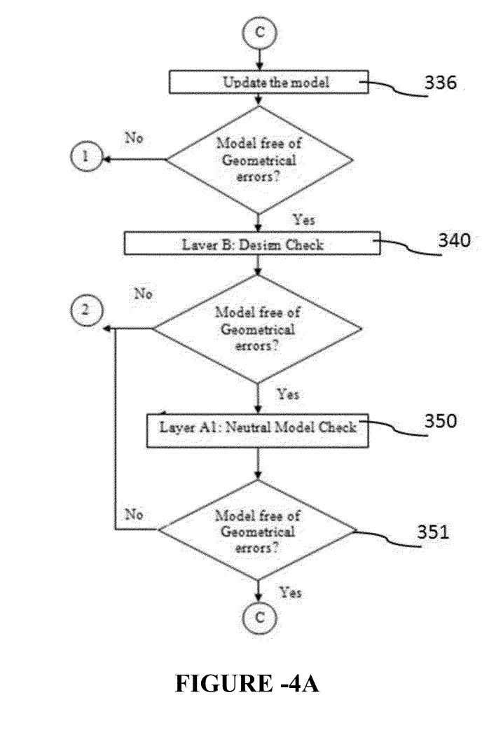

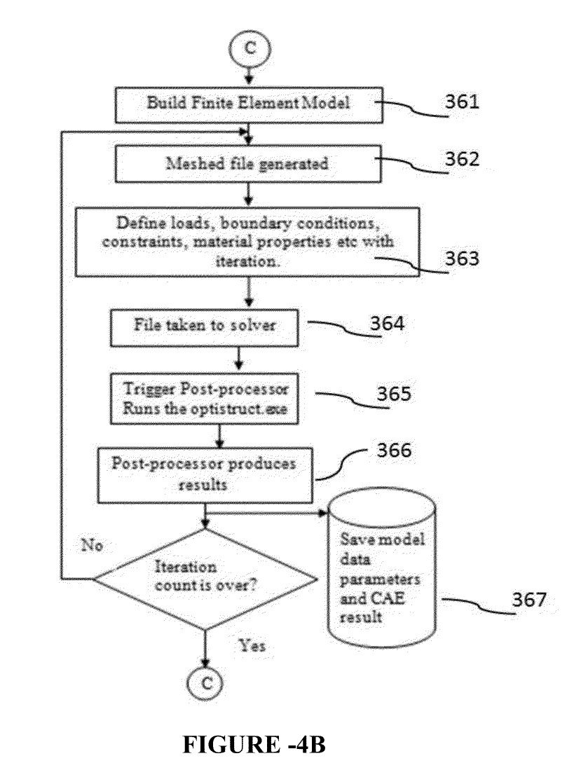

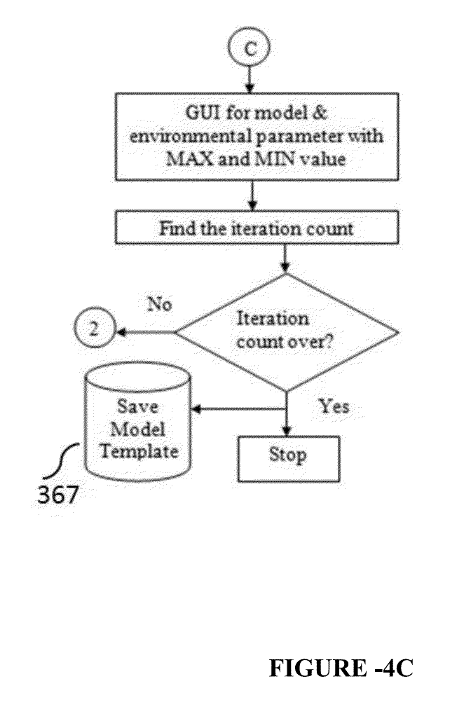

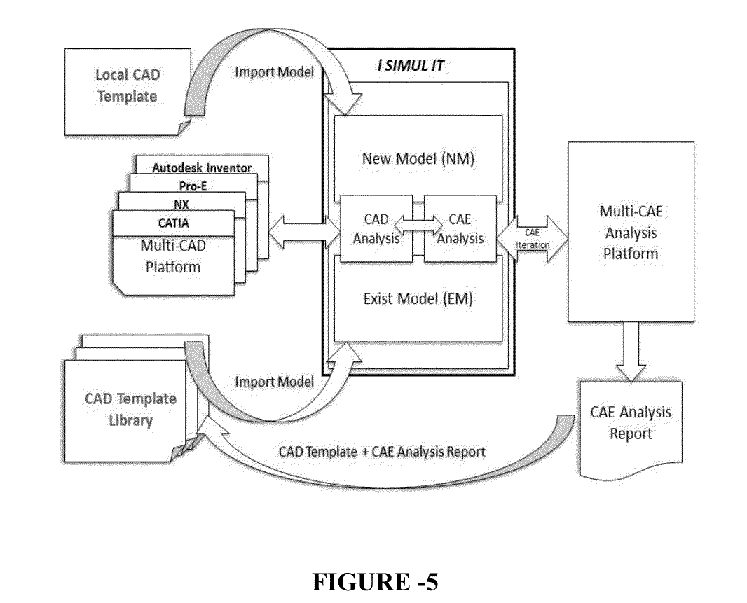

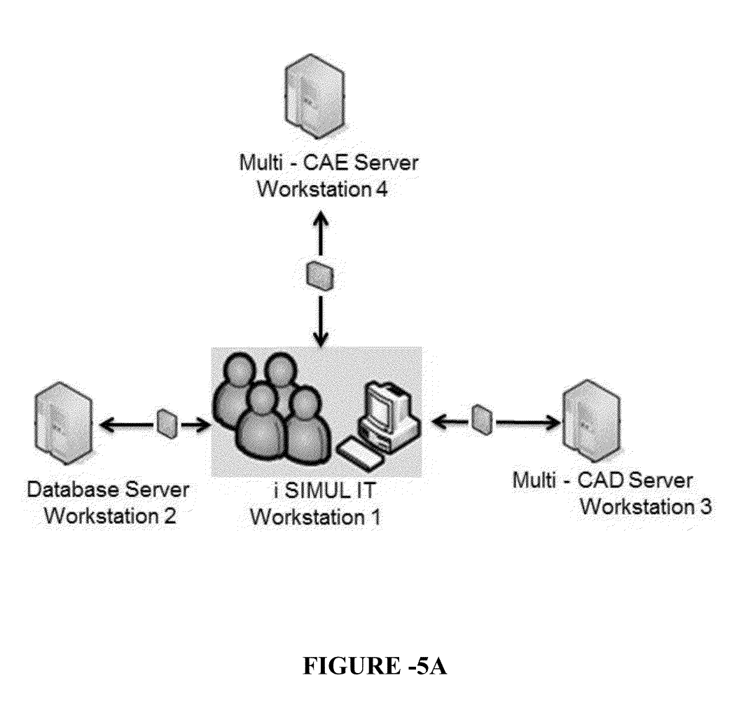

FIGS. 4, 4A, 4B and 4C show the steps on selecting new model (NM) (310). The NM (310) is a Bracket (32) as seen in FIG. 15. Figure number(s), wherever given at the end of a paragraph is of the corresponding computer screen of the system (10).

Since the geometric model is a new model, there is no model template pre-existing in the system (10). A geometric model of the NM (310) is created in the preferred CAD platform (320). The geometric model is opened in the native CAD platform (325), that is, wherein the new model was developed, example CATIA or Pro-E or NX or any other CAD platform.

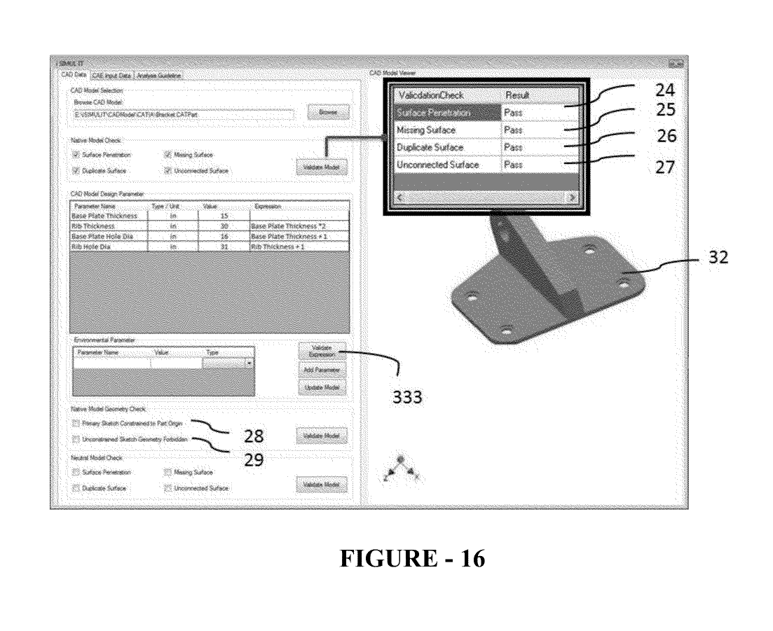

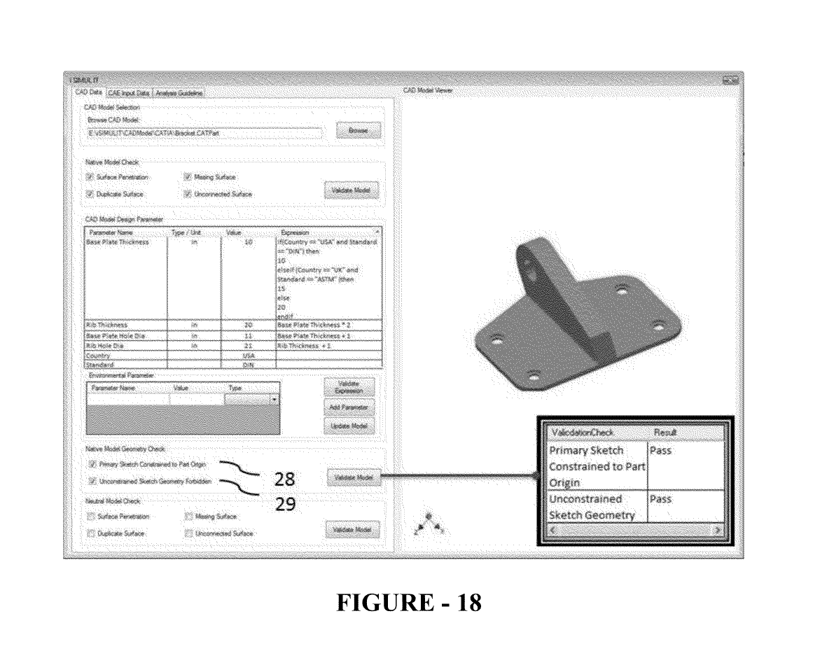

Layer A1: Native Model check (330) is first executed. At this step, the geometric model is checked for geometric errors in the native CAD platform, that is, within the CAD platform where the model is originally developed. Native Model Check (330) is performed by accessing the application programming interface (API) file of the native CAD platform. Geometric errors illustratively include solid model defects, surface penetration (24), missing surface (25), duplicate surface (26), uncorrected surface (27), Constraint to Origin (28), Constrained Geometry (29). Such geometric errors crop in while making the model and are not easily detectable by persons making a CAD model or doing an analysis. The model with geometric errors cannot give useful analysis. FIG. 16, FIG. 18

If the geometric model has geometric errors and is not analyzable, the geometric model is iteratively taken for correction (331).

If the geometric model is free from geometric errors or is assessed to be analyzable, then next execution is Parameter User Interface: Inputs for Model Design Parameter (335), Environmental parameters (334) and Constraints are provided by the user in the form of expressions. Since the model is a NM (310), no expressions may previously exist other than expressions used by a CAD engineer in developing the model. The user collaboratively develops expressions based on skill, experience and domain knowledge.

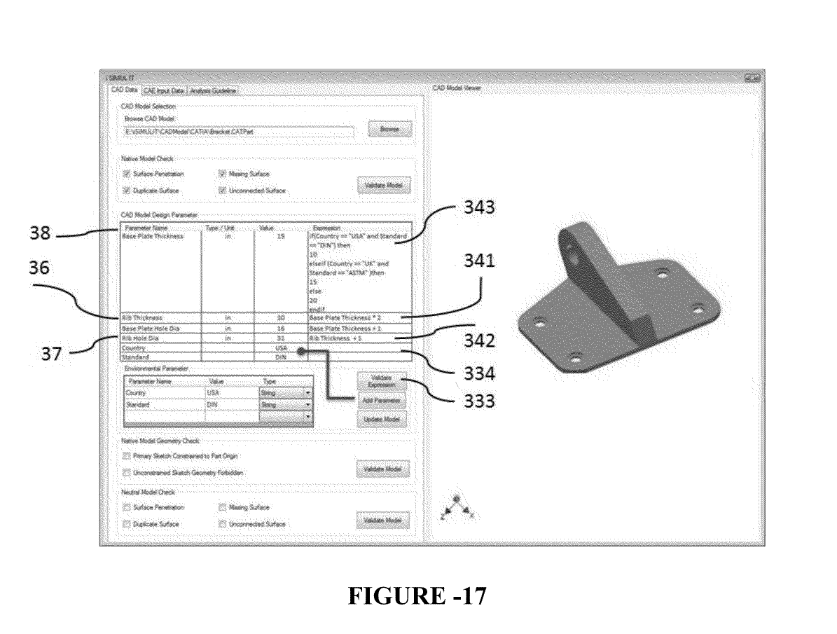

Model Design Parameter Input (335) are already well understood and we describe here the Environmental Parameter (334) Illustratively, The new model or NM (310), here bracket (32), needs to meet criterion set by different international standards, say “DIN” standard at time and say “ASTM” standard at some other time. For the sake of illustration, we assume that Base plate thickness is impacted by such international standards. Such a requirement is external to intrinsic product design and termed as Environmental parameter. An expression (343) is built around the impacted model design parameter (38). FIG. 17.

The expressions are validated for syntax (333) by the user. The model is updated (336).

If the model has geometric errors and is not analyzable, the model is iteratively taken for correction.

Next, comes Layer B: Design Check (340) which is knowledge rules based check. Illustration with respect to Bracket (32):
A rib thickness (36) to be greater than or equal to twice a base plate thickness (38)—see (341). FIG. 17
A rib hole diameter (37) to be greater than or equal the rib thickness (36)+1—see (341). FIG. 17

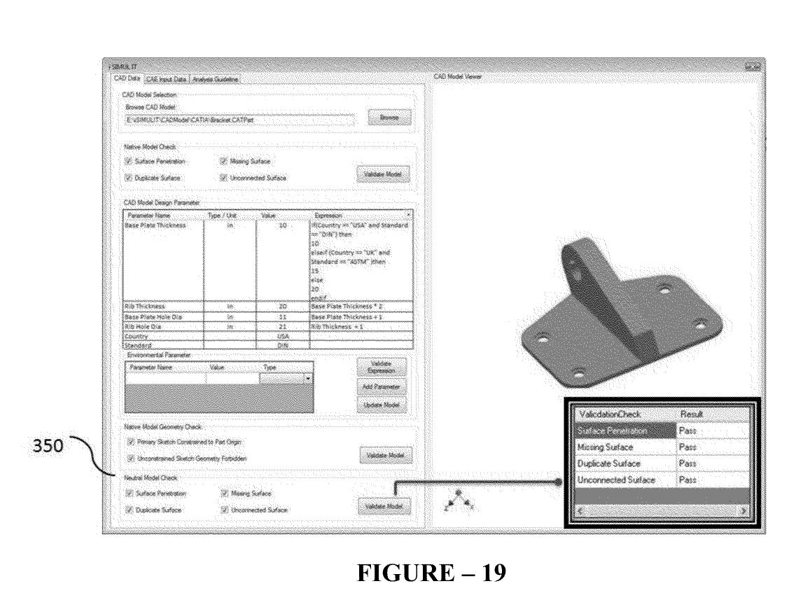

The updated geometric model is saved in a neutral format like .dxf or .iges since, generally, any CAE platforms needs a geometric model in the neutral form. However, it is likely that some geometric errors get formed due to such conversion from the native CAD form to the neutral format, or it is likely that previously existing geometric errors become prominent. Therefore, system as per present invention next executes Layer A2: Neutral Model Check (350). FIG. 19

If the geometric model has geometric errors and is not analyzable, the geometric model is iteratively taken for correction (351).

If the geometric model is free from geometric errors or is assessed to be analyzable, then next execution is CAE analysis. The intent here, however, is to generate a number of solution templates collaboratively for creating a library of solution templates.

As is known, CAE analyses comprises the known steps of
Building Finite Element Model abbreviated as FEM (361)
Defining loads, boundary conditions, constraints and material properties (363)
Solving the Finite Element Model (364)
Post processing the Finite Element Model (365)
Generating result file (366)

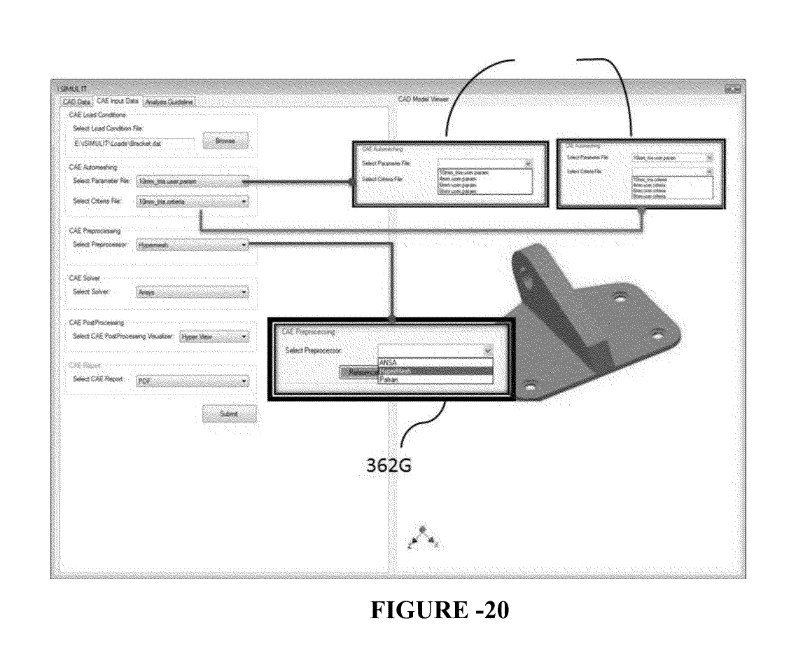

The system is capable of integrating the CAE analysis by selecting any of the different pre-processors (362G), Solvers (364G) and post processors (365G) as shown in FIG. 20 and FIG. 21.

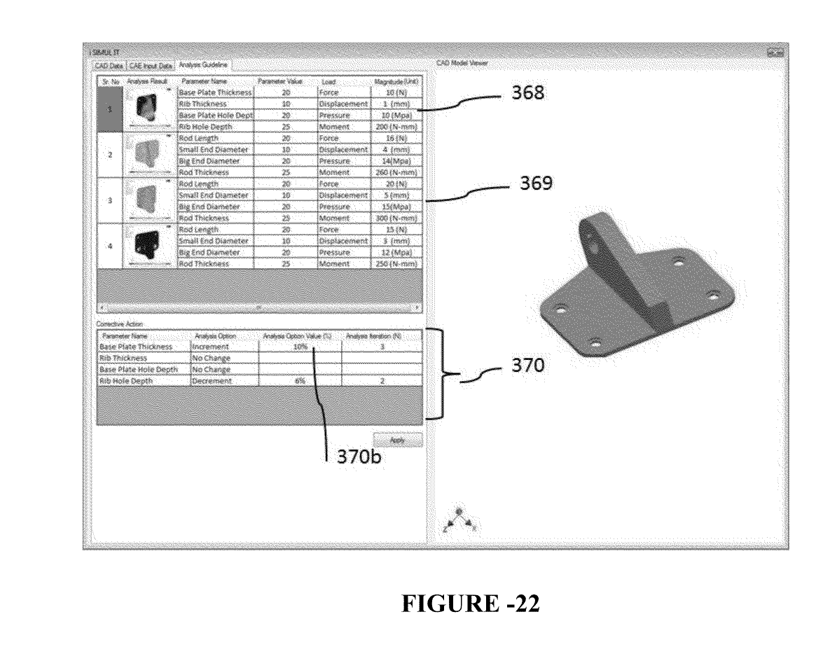

Collaboratively, the CAD and CAE engineer generate a plurality of result files, that is solution templates, by assigning experimental Analysis Option values (370b) and create a library of templates for subsequent use (367). FIG. 22 shows Reference Results (369) which are the solution templates of all analyses, and Analysis Options Menu (370) thus created.

As is understood from above, the NM (310) option of the system causes building a library of solution templates by collective knowledge of a CAD engineer and a CAE engineer on a one time basis, so that subsequent analyses of the erstwhile NM (310), is carried out by the CAE engineer all alone by applying analysis option values and taking reference from solution templates, which are based on knowledge based rules created as hereinabove.

In the embodiment described herein above, the option to create knowledge based rules is available in the EM (110) as well as in the NM (310) mode so that a CAE engineer can use the discretion to apply them even for EM (110) based on his domain knowledge in order to produce better functional performance results without involving a CAD engineer, if he is empowered.

The library of solution templates dynamically grows as the result of every CAE analysis is appended therein. Thus the knowledge base as per the system and the method disclosed is self-enriching and self-refining with continued application of the method and the system.

Since the system is a knowledge based interface, tens of model templates may cumulate for an EM. The CAE engineer elects to either develop another template regardless of availability of an identical model template already, or else uses another software utility to search and select the available template.

The system as per present invention is ancillary to complex PLMs and three-dimensional software suites, which are hugely complex platforms supplementing human capabilities, which our system further complements by providing a knowledge based interfacing between them.

Our inventive system for knowledge based interfacing between computer aided analysis and geometric model, is installable on specific hardware and or workstations which support industrial PLM tools, contemporary CAD platforms and CAE platforms, which are typically workstations with 32/64 bit operating system, with recommended processor speed of 2.0 GHz and with active LAN Adapter.

We claim:

01) A method for a knowledge based interfacing between a computer aided analysis and a geometric model for analyzing a geometric model so as to achieve a desired value of a plurality of performance parameters by a CAE analysis, the method comprising the steps of:
a. Performing a native check for a geometric error on a geometric model of a component;
b. Applying a plurality of knowledge based rules in a native CAD platform;
c. Performing a neutral check for the geometric error on the geometric model of the component;
d. Modifying the geometric model iteratively on detecting the geometric errors which are such that an analysis cannot be continued; and
e. Carrying out a finite element analysis iteratively as per a plurality of analysis option and a library of solution templates,
the knowledge based interfacing being between any, out of a number of, CAD platform with any, out of a number of, CAE platform;
for the geometric model being an existing model, an EM, the plurality of analysis option and a library of solution templates pre-exist;
for the geometric model being a new model, a NM, the plurality of knowledge based rule, the plurality of analysis option and the library of solution templates is generated collaboratively;
the library of solution templates dynamically grows by appending a plurality of result of every CAE analysis.

02) The method for the knowledge based interfacing between the computer aided analysis and the geometric model as claimed in claim 01, wherein the applying of the knowledge based rule in the native CAD platform involves the knowledge based rule in an editable relational engineering rule in the form of an arithmetical or a logical expression.

03) The method for the knowledge based interfacing between the computer aided analysis and the geometric model as claimed in claim 01, wherein the applying of the knowledge based rule in the native CAD platform involves the knowledge based rule in an editable functional engineering rule in the form of an arithmetical or a logical expression.

04) The method for the knowledge based interfacing between the computer aided analysis and the geometric model as claimed in claim 01, wherein the applying of the knowledge based rule in the native CAD platform involves the knowledge based rule in an editable environmental engineering rule in the form of an arithmetical or a logical expression.

05) The method for the knowledge based interfacing between the computer aided analysis and the geometric model as claimed in claim 01, wherein the performing of the neutral check for the geometric error involves the geometric error in a solid model defect.

06) The method for the knowledge based interfacing between the computer aided analysis and the geometric model as claimed in claim 01, wherein the performing of the neutral check for the geometric error involves the geometric error in a surface defect.

07) The method for the knowledge based interfacing between the computer aided analysis and the geometric model as claimed in claim 01, wherein the performing of the neutral check for the geometric error involves the geometric error in a geometric constraint.

08) A System in a form of a computer program residing on a computer processor, the computer processor being part of a computer system, comprising of one or more computer readable storage media having computer-executable instructions of a plurality of computer aided design (CAD) software platform and a plurality of computer aided engineering (CAE) software platform embodied thereon or connected therewith, wherein the computer program as per the system, when invoked, causes, as per user interface selection, execution of knowledge based interfacing between a Computer Aided Analysis and a Geometric Model, in the form of:
a. Selecting between an EM or a NM
b. On selecting the EM
i. Electing and importing a model template of the EM in the CAD platform wherein the geometric model was developed.
ii. Executing a Layer A1: Native Model check.
iii. Inputting and or editing a plurality of Engineering based rules
iv. Applying the plurality of knowledge based rules
v. Updating the EM
vi. Checking the EM for geometric errors.
vii. Executing a Layer B: Design Check
viii. Saving the updated model in neutral format
ix. Executing a Layer A2: Neutral Model Check
x. Building a Finite Element Model
xi. Defining loads, boundary conditions, constraints and material properties
xii. Solving the Finite Element Model
xiii. Post processing the Finite Element Model
xiv. Iteratively modifying the geometric model a per a CAE analysis result & selecting an Analysis Option value correspondingly
xv. Generating a result of CAE analysis
c. On selecting the NM
i. Creating and importing a template of the existing geometric model in the native CAD platform.
ii. Executing the Layer A1: Native Model check (Layer A1).
iii. Updating the geometric model
iv. Checking the geometric model for the geometric errors.
v. Inputting and or editing the plurality of Knowledge based rules collaboratively by providing a plurality of expressions for model design parameters and Environmental parameters
vi. Validating the plurality of expressions
vii. Updating the geometric model as per the knowledge based rules
viii. Executing Layer B: Design Check
ix. Saving the updated geometric model in neutral format
x. Executing Neutral Model Check (Layer A2)
xi. Building a Finite Element Model
xii. Defining loads, boundary conditions, constraints and material properties
xiii. Solving the Finite Element Model
xiv. Post processing the Finite Element Model
xv. Creating analysis options for desired performance parameters
xvi. Running the CAE analysis repeatedly for different values of desired performance parameters
xvii. Analyzing the CAE results and refining model design parameters
xviii. Generating a library of solution templates on detecting such geometric errors while executing the Layer A1:Native Model check that the CAE analyses cannot be undertaken, the geometric model is modified iteratively, on detecting such geometric errors while executing the Layer A2: Neutral Model check, that the CAE analyses cannot be undertaken, the geometric model is modified iteratively, on detecting such geometric errors while executing Layer B check that the CAE analyses cannot be undertaken, the geometric model is edited iteratively by changing parameter values, the system interfaces by user based selection between any, out of a number of, CAD platform with any, out of a number of, CAE platform.

09) The system as claimed in claim 08 wherein, said native model check is performed by accessing the application programming interface (API) file of the native CAD platform.

10) The system as claimed in claim 08 wherein, said CAE result is studied by an arithmetic assessment of an obtained value of performance parameter like a displacement, a stress, a temperature and comparison with a desired value, or by a pixel assessment of obtained shades of a differential color image with a desired values.

11) The system as claimed in claim 10 wherein, said CAE result is studied by a combination of the arithmetic assessment and the pixel assessment

12) The system as claimed in claim 10 wherein, said CAE result is studied also by a logical assessment of values of an obtained result as extracted from an application programming interface (API) file of the CAE platform.

13) The system as claimed in claim 08, wherein said selecting the model template of the EM is by an independent software utility.

14) The system as claimed in claim 08 wherein, the library of solution templates dynamically grows by appending a plurality of result of every CAE analysis.
